(19) United States
(12) Patent Application Publication
(10) Pub. No.: US 2007/0133904 A1
(43) Pub. Date: Jun. 14, 2007

(54) Image processing method

(76) Inventor: Ichiro Hagiwara, Tokyo (JP)

Correspondence Address: WELLS ST. JOHN P.S., 601 W. FIRST AVENUE, SUITE 1300, SPOKANE, WA, 99201, US

(21) Appl. No.: 10/547,224

(22) PCT Filed: Feb. 24, 2004
(86) PCT No.: PCT/JP04/02129

§ 371 Date: Nov. 6, 2006

(30) Foreign Application Priority Data
Feb. 26, 2003 (JP) 2003-048370

(51) Int. Cl. G06K 9/32

(52) U.S. Cl. 382/300

(57) ABSTRACT

There is provided an image processing method for performing image processing at a high speed with a high accuracy by using the CSRBF method. The image processing method for processing an object image includes a step (Step 12) for creating function data, i.e., the object image expressed with a function and a step (Step 13) for performing image processing so that the object image becomes a desired image by using the created function data. When creating the function data, a high-speed algorithm is used (Step 11) for creating a diagonal matrix for a parameter of a basis function in the CSRBF method. The image processing includes image resolution interpolation, compression, scratch repair, animation creation, and the like.

### BACKGROUND OF THE INVENTION

1. Field of the Invention

The present invention relates to an image processing method and particularly to an image processing method in which image processing is performed at a high speed in accordance with the CSRBF (Compactly Supported Radial Basis Functions) method.

2. Description of the Related Art

In response to the advancement of digitization of information, electrical communication lines such as Internet have developed rapidly. Based on that, various types of image processings of an image, which is one of the contents of the digitization, have been practiced generally. Image processings with a computer have been carried out frequently in order to make images to be desirable images. As a result, various requests on, for example, improving the processing speed and processing accuracy have been raised increasingly.

For example, some types of the image processings are performed with use of resolution interpolation. A digital camera, an image scanner and the like have been developed as an image input device, and a monitor such as a personal computer, a printer, a portable information terminal such as a portable telephone and a PDA and the like have been developed as an image output device. The image resolution given with these devices differ manifoldly from one to another. When an image file is outputted to an output device, it is necessary to adjust the file to the resolution of the output device, if the file contains a pixel image having been generally used. In particular, when a whole screen display such as so-called a wallpaper image is the basic image, the image provider has been required to convert the resolution of an original image file to produce a plurality of image files with an image resolution which is compatible to the resolution of each image output device, that is a device being in hand of the receiver. Otherwise, the resolution of an image file has been converted by the receiver sometimes. For the modification of the image resolution as described above, various interpolation techniques, such as the zero-th holding method, the linear interpolation method, the subdivision method, have been proposed.

Besides, compression of an image is another technique for processing an image. Since non-compressed data in the form of BMP or the like makes a file capacity of data unnecessarily large, a data is generally compressed into a compressed data such as the JPEG form in order to hold the capacity less when an image data is transmitted and/or received through the Internet. As a technique to compress an image, techniques such as the discrete cosine transform to be used in the form of the JPEG and the like and the wavelet transform such as the JPEG 2000 have been known. The image compression is purposed to make a file capacity less while maintaining the image resolution. When it is desired to effect an image compression with altering an image resolution, it is required to perform calculations for the inverse conversion at every occasion where desired because said alteration and compression are carried out with separate means, but not at the same time.

Further, some techniques to restore a partial region in an image data that, for example, has been damaged or lost have also been known. Examples of these techniques include a process to copy a sample collected from the perimeter of a damaged region of an image and paste the tone, the texture and the like of the sample onto the damaged region to thereby blot the damaged region with the surrounding data, and a process to restore only a requisite region while retaining the tone and texture of the image. These techniques are designated as so-called croning process. Besides, there is a further technique that employs partial differential equations.

In addition, a process to alter an image to create an animation is also included in the image processing techniques. The animation, that is a technique to create animated images, contains the morphing technique that forms intermediate images for supplementing images so that a state of an object that is changing from a form to the other form can be expressed with animated images. By repeating preparations of the intermediate images many times based on the elements of the anterior and posterior images, smoothly-moving animated images can be attained.

Besides, the CSRBF method is known as one of techniques for reconstituting a surface of an object image. With this process, an object is expressed with its functions, and the process is based on certain spline functions and spherical functions. In contrast to the RBF process of which processing speed being slow, the basis functions are made compact in the CSRBF method. Since the reconstitution of a surface is effected with use of radial basis functions having a compact base, the calculation speed of the CSRBF method is faster than that of the RBF process.

However, although the CSRBF method is a method to express the shape of an object with the functions, the amount of the calculation with the CSRBF method becomes enormous. Therefore, there is an example in which a high-speed algorithm that reduces the amount of calculation to thereby accelerate the processing speed for effecting the expression with the functions is developed.

Incidentally, the prior arts in relation to the image processing are disclosed in the following references.

Hitoshi Takaya: Easy-to-understand digital image processings, published by CQ Publishing, February 1996; Nikita Kojekine, Valdimir Savchenko, Dimitrii Berzin and Ichiro Hagiwara: Software tools for compactly supported radial basis functions, IASTED Fourth International Conference on Computer Graphics and Imaging, Honolulu, Hi., Aug. 13-16, 2001, pp. 234-239.

However, when an image resolution is transformed, it is difficult for a pixel image having been generally used to use a single image file to thereby effectively deal with outputs with various resolutions. This is because only the equimagnified interpolation of the original image can be effected with the interpolation processes, such as the zero-th holding process, the linear interpolation process and the subdivision process, and it is therefore not possible to output the image at an arbitrary resolution other than the equimagnification. Further, it has been noted that unclear images and jaggies at the edges are generated if the interpolation is carried out incompletely. Accordingly, the more the types of output devices with different resolutions increase, the more the generation of an image being applicable to such output devices has become difficult. Furthermore, substantial period of time has been required for effecting the transformation of image resolution.

On the other hand, in the processing of an image on an electric communication network or the like, there is a case in which an image resolution is transformed and an image is then compressed further. In such a case, it has been troublesome in terms of handling and time-consuming because inverse conversion calculations are required at every occasion for those processings.

Besides, with respect to the restoring process of damaged region in an image, there is such a problem for the croning process that the process imposes a redundant operation even for a small restoring, whereas for a process employing the partial differential equations that it cannot be used suitably when the damaged region extends over a wide range.

Further, the conventional softwares for creating animations have lacked the simplicity for expressing changes in shapes. Since the expression of changes in shapes is a complex work, a great amount of time has also been required for performing the morphing.

Besides, there has been no case in which the CSRBF method for expressing an object image with the functions is employed for the image processing.

Taking the above-described circumstances into consideration, the present invention is contemplated to provide an image processing process capable of executing image processings at a high-speed and with a high accuracy with use of the CSRBF method.

### SUMMARY OF THE INVENTION

In order to achieve the above-described object of the present invention, the image processing method according to this invention comprises a process to produce the functional data that express the object image with the functions with use of the CSRBF (Compactly Supported Radial Basis Functions) process and a process to use the produced functional data in the process to produce the functional data to effect the image processing so that the object image is obtained in the form of a desired image.

In the CSRBF method, the basis function is provided with the functions represented by the following equation;

$$ϕ ( {P}_{i} , {P}_{j} ) = \{ \begin{matrix}{( 1 - \frac{r ( {P}_{i} , {P}_{j} )}{{r}_{0}} )}^{2} , & r ( {P}_{i} , {P}_{j} ) < {r}_{0} \\ 0 , & others\end{matrix}$$

wherein r(Pᵢ, Pⱼ) is defined as a distance between two arbitrary points Pᵢ and Pⱼ among a plurality of discrete points, and r₀ is defined as a radius that centers an arbitrary point Pi to be given as the initial value, and the functional data based on the basis function is provided with the functions represented by the following equation;

$$f ( x , y , z ) = {\sum }_{i = 1}^{N} ( {λ}_{i} ϕ ( x , y , z , {P}_{i} ) ) + {λ}_{N + 1} + {λ}_{N + 2} x + {λ}_{N + 3} y + {λ}_{N + 4} z$$

wherein λᵢ(i=1, 2, . . . , N) denotes a coefficients of the basis function at the point Pi, and λ_{N+1}, λ_{N+2}, λ_{N+3} and λ_{N+4} are denote primary term coefficients. With this concern, the calculations of the coefficients, λ_{N+1}, λ_{N+2}, λ_{N+3} and λ_{N+4}, are carried out with use of a high-speed algorithm that diagonalizes interpolation matrices. The high-speed algorithm comprises a first step wherein one point is added from the initial data containing the plurality of discrete points to a list and the point added to the list is deleted from the initial data, a second step wherein a point in the vicinity of the point having been added in the first step is retrieved from the initial data to be added to the list and the point having been added to the list is deleted from the initial data, a third step wherein a point in the vicinity of the point having been added in the second step is retrieved from the initial data to be added to the list and the point having been added to the list is deleted from the initial data, a fourth step wherein one point is added from the discrete point remaining in the initial data to the list when no more point to be added to the list exists and the point having been added to the list is deleted from the initial data, and a fifth step wherein the first to fourth steps are repeated until no more discrete point remains in the initial data to thereby produce diagonal matrices having a band characteristic.

The process in which the image processing is performed includes a process to perform image interpolation that uses the functional data to increase or decrease the number of samplings form a coordinate so that the object image with a desired image resolution is obtained. Further, prior to the process of producing the functional data, a process to perform a preprocessing to the object image may be included. The process in which the preprocessing is performed is a process to perform the wavelet transform in order to extract the characteristics of the object image. Alternatively, a process for performing simply thinning of the plurality of discrete points may be included in order to compress the capacity of the object image.

The basis functions may be defined further with the following equation wherein a radius and a pixel value are used as the parameters;

$$ϕ ( {P}_{i} , {P}_{j} ) = \{ \begin{matrix}{( 1 - \frac{r ( {P}_{i} , {P}_{j} )}{{r}_{0}} )}^{2} , & r ( {P}_{i} , {P}_{j} ) < {r}_{0} , p ( {P}_{i} , {P}_{j} ) > {p}_{0} \\ 0 , & others\end{matrix}$$

wherein p(Pᵢ, Pⱼ) denotes a difference between two arbitrary points Pᵢ and Pⱼ and the pixel value, and p₀ denotes a difference between the arbitrary point Pᵢ and the pixel value.

Besides, the process in which the image processing is performed is a process to restore a damaged part contained in the object image. The image processing method according to the present invention further comprises a process to define the damage part contained in the object image and a process to define the remaining region of the object image from which the damaged part has been removed, prior to the process for producing the functional data. Then, the process for producing the functional data is performed against the remaining region having been defined, and, in the process for restoring the damaged part, the damaged part is restored by interpolating the damaged part having been defined with use of the functional data against the defined remaining region, which has been produced in the process of producing the functional data.

Alternatively, the damaged part contained in the object image is restored in the process for performing the image processing, the image processing method includes a process to define the damaged part in the object image, a process to determine a given point in the range of the damaged part having been defined and a process to specify a given peripheral region that is adjacent around said given point, prior to the process to produce the functional data. Then, the process to produce the functional data is performed against the given peripheral region having been specified, and the functional data against the given peripheral region having been specified, that is produced in the process to produce the functional data, is used to interpolate the given point to thereby restore the given point in the process to restore the damaged part. Following to the completion of the restoration of the given point, the operation is backed to the process for determining a given point in order to determine the next given point, and the processes up to the process to restore the point are repeated to thereby restore all damages in the damaged part having been defined.

Alternatively, it may be configured such that an animation is created by modifying the object images in the process to perform image processings and the image processing method further comprises a process to specify the parts having moving elements in the object images prior to the process to produce the functional data. Then, the process to produce the functional data is performed against the specified parts having moving elements, and the animation is then created in the process to create an animation by modifying the parts having moving elements to the linear form with use of the functional data against the specified parts having moving elements, that is produced in the process to produce the functional data.

According to the processes as described above, the following advantageous effects can be attained. That is, the object images can be transformed into the functional data at a high-speed, and the object images can be processed with high accuracy within a short time so that they are formed into the desired images. For example, since the object images have been transformed into the functional data, the degrees of those image resolutions may be converted to an arbitrary resolution at a high-speed by just increasing or decreasing the number of the samplings. In addition, accurate compression of those object images is capacitated as well. Yet further, damaged parts in the object images can be restored at a high-speed with a high accuracy even though the damaged parts are fine and extended widely. Still further, it is made easy to modify the shapes of images, the creation of an animation can be achieved at a high-speed. Besides, since calculation works required for the image processing can be reduced, real time animations and the like will be created in a comfortable working fashion without employing high performance computers.

### BRIEF DESCRIPTION OF THE DRAWINGS

FIG. 1 is a flowchart for explaining the flow of the image processing method employing the CSRBF method according to the present invention,

FIG. 2 is a flowchart for explaining the flow of the high-speed algorithm employing the CSRBF method according to the present invention,

FIG. 3 is an exemplary program for realizing the high-speed algorithm employing the CSRBF method according to the present invention,

FIG. 4 is a table for explaining a process in which discrete points are rearranged in accordance with the high-speed algorithm employing the CSRBF method according to the present invention,

FIG. 5 is a table showing an example of the diagonal matrices having band characteristic which are produced by the high-speed algorithm employing the CSRBF method according to the present invention, and

FIG. 6 is a flowchart for explaining the flow when a preprocessing is carried out in the image processing method employing the CSRBF method according to the present invention.

### DETAILED DESCRIPTION OF THE PREFERRED EMBODIMENTS

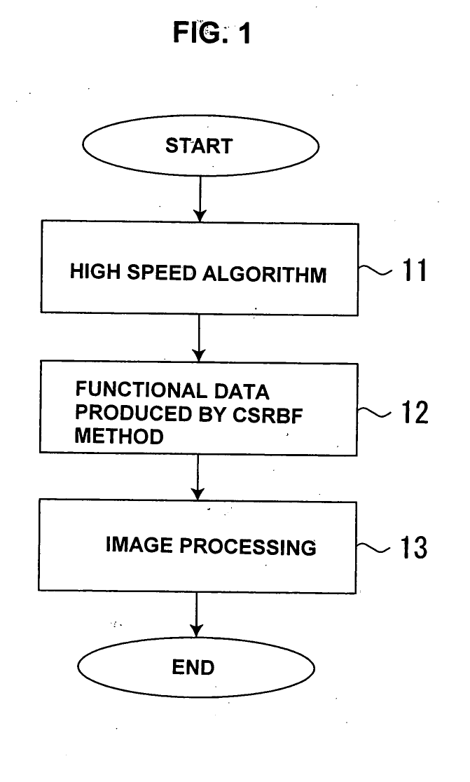

Several embodiments for the present invention will be explained in the following with the examples shown in the appended drawings. FIG. 1 is a flowchart for explaining the outline of the image processing method according to the present invention. At first, diagonal matrices are produced by means of the high-speed algorithm for the parameters of the basis functions according to the CSRBF method (Step 11). Then, the produced diagonal matrices are used to produce the functional data in accordance with the CSRBF method (Step 12). As a result, the object images can be expressed with the functions. Following thereto, the images are processed with use of the produced functional data according to the CSRBF method (Step 13). In the following, the CSRBF method will be described specifically.

The CSRBF method used in this invention is one of the techniques for reconstituting the surface of an object, producing an implicit function f(x, y, z) from a discrete point (x, y, z). The basis function in the CSRBF method is defined as follows;

$$ϕ ( {P}_{i} , {P}_{j} ) = \{ \begin{matrix}{( 1 - \frac{r ( {P}_{i} , {P}_{j} )}{{r}_{0}} )}^{2} , & r ( {P}_{i} , {P}_{j} ) < {r}_{0} \\ 0 , & others\end{matrix} \qquad ( 1 )$$

wherein r(Pᵢ, Pⱼ) denotes a distance between two arbitrary points Pᵢ and Pⱼ among a plurality of discrete points, and r₀ denotes a radius centering the arbitrary point Pᵢ to be given as the initial value.

Then, for a sphere having a radius r₀ from the centered arbitrary point Pᵢ, distances to the center Pᵢ are determined for all of the discrete points in the sphere. At this occasion, the functional data is given with the functions represented by an equation described below;

$$f ( x , y , z ) = {\sum }_{i = 1}^{N} ( {λ}_{i} ϕ ( x , y , z , {P}_{i} ) ) + {λ}_{N + 1} + {λ}_{N + 2} x + {λ}_{N + 3} y + {λ}_{N + 4} z \qquad ( 2 )$$

wherein λᵢ (i=1, 2, . . . , N) denotes coefficients of the basis functions at the point Pᵢ, and λ_{N+1}, λ_{N+2}, λ_{N+3} and λ_{N+4} denote primary term coefficients. In the CSRBF method, these coefficients are used to carry out reconstitution of the surface.

Here, the functional data specifically means an image data in which the function f(x, y, z) is contained. In this concern, the functional data may contain only said function or the other information therewith.

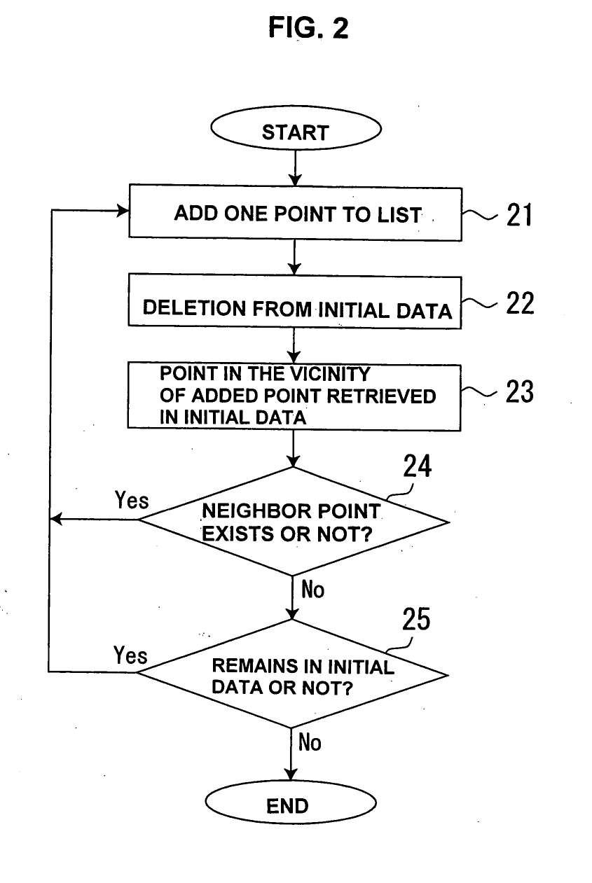

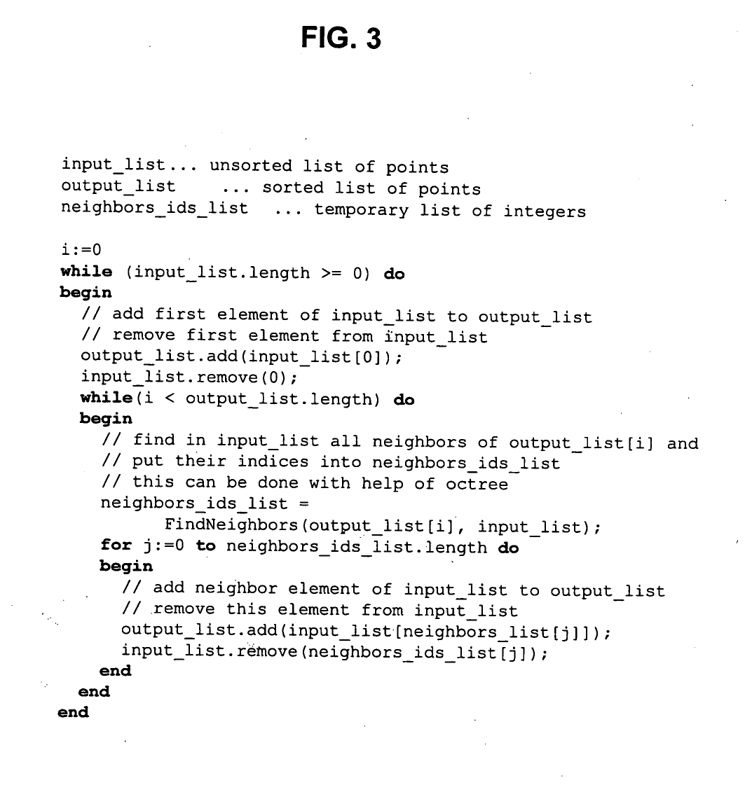

In the present invention, the high-speed algorithm is used to reconstitute interpolation matrices (SLAE matrices) to be constituted by calculations to the diagonal matrices with band characteristic according to Yabuki in the calculations of spline coefficients, λ_{N+1}, λ_{N+2}, λ_{N+3} and λ_{N+4}, among the functions given in the description above. The use of the algorithm is purposed to reduce the calculation works with a computer when a number of discrete points exist. Note that, when all the spline coefficients are superimposed, a smooth functional system that passes through all of the points can be produced. In the following, the flow of the high-speed algorithm for executing the diagonalization specified in this invention will be explained with referring to FIG. 2. At first, one point is added from the input list containing a plurality of discrete points to the output list (Step 21), and the point added to the output list is deleted from the input list. Then, a point in the vicinity of the added point is retrieved in the input list (Step 22). If the point in the vicinity is found (Step 24), the procedure backs again to Step 21, the point having been found is then added to the output list, and the point added to the output list is deleted from the input list (Step 22). Then, a point in the vicinity of the added points is retrieved again in the input list (Step 23). Step 21 through Step 24 are repeated until no point is found in the vicinity of the added point in the input list. When no point in the vicinity is found (Step 24), it is checked whether the discrete points still remain in the input list or not (Step 25). If the discrete points are still remain, the procedure backs again to Step 21 to add one of the remaining discrete points to the output list. Then, the point added to the output list is similarly deleted from the input list (Step 22), points in the vicinity of the added point is retrieved again in the input list (Step 23). In such a manner, Steps 21 through 25 are repeated until no discrete point remains in the input list. As a result, diagonal matrices having band characteristic (band matrices) are produced. With this high-speed algorithm and executing calculations of the rearranged matrices, the time required for calculating the coefficients, λ_{N+1}, λ_{N+2}, λ_{N+3} and λ_{N+4} can be reduced. The program that can realize the above-described algorithm may be, for example, that shown in FIG. 3.

Now, an example in which the above-described high-speed algorithm is applied to an image of a cube containing six discrete points (1, 2, 3, 4, 5, and 6) will be explained. It is assumed that the six discrete points are respectively provided with the neighbor points in an arbitrary sphere as follows.

Neighbor points for the discrete point 1: 1, 3, 6

Neighbor points for the discrete point 1: 2, 5

Neighbor points for the discrete point 3: 1, 3, 4

Neighbor points for the discrete point 4: 3, 4

Neighbor points for the discrete point 5: 2, 5

Neighbor points for the discrete point 6: 1, 6

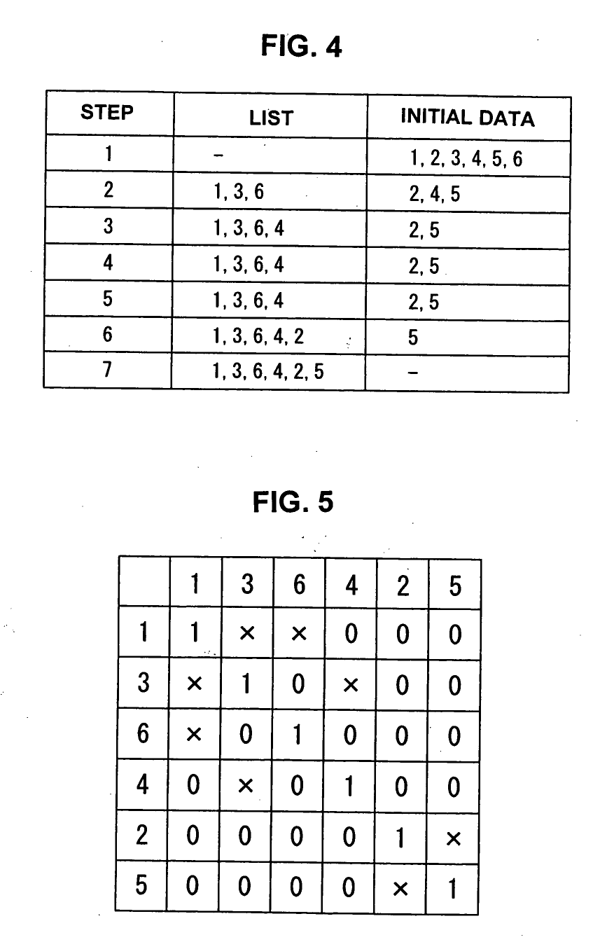

When the high-speed algorithm according to the present invention is applied to the six discrete points, the matrix of the discrete points are arranged to a matrix of (1, 3, 6, 4, 2, 5) as shown in FIG. 4, and a diagonal matrices having band characteristic (SLAE matrix) as shown in FIG. 5 is produced from the rearranged matrix. Note that a mark × in FIG. 5 denotes a distance between two points. As a result of utilizing the high-speed algorithm, the parameters required for the CSRBF method can be calculated at a high speed. Therefore, with this manner, the calculation of the functions according to the CSRBF method can be executed at an extremely high speed.

Besides, when the radius r₀ is large at the basis functions, most of the points are included in the sphere with a radius r₀ centering the arbitrary point Pᵢ. Thus, it is required to produce a storing space with more capacity for the diagonal matrices in comparison with the matrices before the rearrangement. However, as a result of the reduction of the radius r₀, it is made possible to utilize the matrix that has less storing space and has become the best result. The radius r₀ may be determined empirically so that images with high accuracy can be produced within a short time.

Further, although the function f(x, y, z) is an expression for a three-dimensional image, it is considered that z is zero for a two-dimensional image and a function f(x, y) can be given for it. Yet, the color information on an image can be given with the functional values. For example, when a function f(10, 20)=30 is given, it means that a point having a value of 10 on the x-coordinate and 20 on the y-coordinate has color information of 30.

Besides, the discrete points may be points distributing in a lattice state or points distributing discretely. For example, in case of an image of which original image having pixels of 160×120, although the discrete points reach to 19,200 when the functions are produced with the overall image, the discrete points come to a less number when the preprocessing as described later is carried out. For example, when only 10% of the points are used, the number of the discrete points comes to 1,920. Note that the 1,920 discrete points maybe arranged in a lattice state, however, when it is intended to extract the characteristic points as described later, the discrete points exist irregularly along the characteristic points.

Now, an image processing method employing the above-described CSRBF method will be explained in detail in the following. The image processing according to the first example for the present invention is directed to modifications of the image resolution. The modification of the image resolution means to execute image interpolation by increasing/decreasing the number of pixels so that the image has an arbitrary resolution. At first, utilizing the CSRBF method according to the present invention, functional data that expresses an original object image with the functions is produced. Since it is possible to express the overall object image with the functions, it is needless to make calculations of the functions afterward if the functional data has been once produced, so that the conversion of the resolution can be made with a high accuracy within a short time. For example, by performing sampling at a distance that is obtained by dividing the whole functional data on the x-axis by a desired number of pixels on the x-axis, an image with a desired image resolution can be attained with a high accuracy. More specifically, when an original image has pixels of, for example, 120×160, an image may be reconstituted with the number of samplings that is obtained by dividing the whole (120) of the x-axis by 120 and the whole (160) of the y-axis by 160 in order to output an image having a resolution equivalent to the resolution of the original image. Then, the image resolution may be increased/decreased by increasing/decreasing the number of sampling from the coordinate. For example, when it is desired to acquire an image with pixels of 150×200 having been image-interpolated to 1.25 times, an image with pixels of 150×200 can be acquired by executing samplings at a distance that is attained by dividing the whole (120) of the x-axis by 150 and the whole (160) of the y-axis by 200. Note that the time required for an image processing according to this invention under an environment in which a computer equipped with Intel (Trade name) Pentium (Trade name) 41.7 GHz and 512 MB memory and Microsoft (Trade name) Windows (Trade name) 2000 as OS are used is, foe example, about 0.4 sec. more or less and about 0.6 sec. more or less for an interpolating process to 1.25 times from pixels of 120×160 to pixels of 150×200 and for an interpolating process to 1.5 times to pixels of 180×240, respectively. Note that, for reference, the program for supplementing the image resolution was prepared with Microsoft (Trade name) Visual C++ (Trade name) 6.0. With the image processing method in which the high-speed algorithm employing the CSRBF method according to this invention is used, extremely high speed processings are capacitated even for such a conversion in the image resolution. Although the conventional interpolation process can be applied only for equimagnified interpolation of an original image and a longer time is required for the image processing, the interpolation to an arbitrary resolution is capacitated with a high accuracy and at a high speed with the present invention by only increasing/decreasing the number of samplings from the coordinate so that a requisite resolution can be attained. Accordingly, since an image can be reconstituted into an image with an arbitrary resolution at a high speed so as to be compatible with the performance of the receiver's device when an image is transmitted on an electric communication line such as Internet, it will be enough for the transmitter to provide only an original image. Thus, it is made possible to provide an image in such a manner that can fully utilizes the performance of the receiver's output device by outputting an image with a high resolution for a wallpaper image and printing uses for a computer and an image with a low resolution for a portable terminal of a portable telephone or the like depending on the performance of the receiver's device.

Note that, the format of a file may be made with use of spline coefficients instead of RGB values which have been conventionally used when expressing with a bit map. With employing such a format, the interpolation of an image into that with an arbitrary resolution can be effected within a short time.

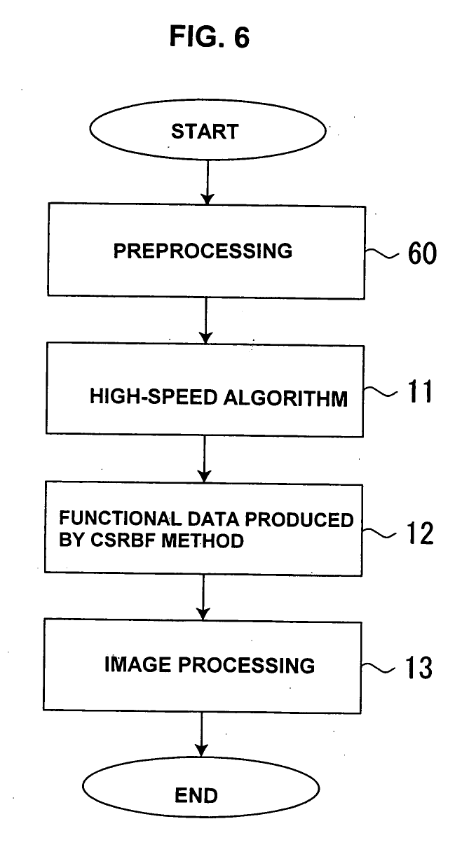

Next, the image processing method according to the second example of the present invention will be explained. In this example, an image processing is carried out following to executing a preprocessing to an original image, before producing the functional data. FIG. 6 is a flowchart for explaining the image processing method according to the second example of the present invention. In this drawing, the same reference symbols as those in FIG. 1 denote the same processing steps, respectively. As shown in FIG. 6, a preprocessing is executed at first (Step 60), and a diagonal matrices are then produced with use of a high-speed algorithm (Step 11). If the calculations according to the CSRBF method are applied to all discrete points, the calculation works becomes enormous, thus rendering the time required for carrying out the calculations longer on occasions. Hence, it is considered to simply thin the discrete points. Namely, the discrete points are simply thinned as the preprocessing. With this preprocessing, the calculation works can be reduced, so that the time required for the image processing can be shortened. It is expectable that the simple thinning of the discrete points may provide an effect of compressing the capacity of an object image. Since the whole object image can be expressed with the functions with the present invention, the image interpolation and the compression can be executed simultaneously. However, when the thinning has been made, there is such a case that the processed image appears in more out-of-focus state in comparison with the original image. Although the processed image will be practically acceptable depending on the use, a preprocessing to thin point data is required in order to minimize the loss of information so that an image with more accuracy can be attained. Specifically, such a processing that thins point data from a portion being redundant as an image and remains point data in the important portion is executed. That is, the discrete points are thinned efficiently by extracting the characteristic portions in an image. This processing can be realized by utilizing, for example, the wavelet transform. The points are thinned with a low pass filter of the wavelet, and the characteristic pointes are extracted with a high pass filter of the wavelet. With the preprocessing as described above, the thinning of the discrete points is not. executed for the contours and high contrast portions of an image to maintain the details of the image at a high level, while the redundant portions such as background can be thinned. Therefore, the calculation works for calculating the parameter of the functional data can be reduced. Note that, for the preprocessing, the other techniques such as the discrete cosine transform can be used in addition to the wavelet transform.

Next, the image processing method according to the third example of the present invention will be explained. When the image resolution interpolation is carried out to an object image, there is such a problem that a potion of the image with a distinctively-different color and the like gets in an out-of-focus state. Thus, the parameters of the basis functions expressed with the above-described equation (1) are defined with the following equation;

$$ϕ ( {P}_{i} , {P}_{j} ) = \{ \begin{matrix}{( 1 - \frac{r ( {P}_{i} , {P}_{j} )}{{r}_{0}} )}^{2} , & r ( {P}_{i} , {P}_{j} ) < {r}_{0} , p ( {P}_{i} , {P}_{j} ) > {p}_{0} \\ 0 , & others\end{matrix} \qquad ( 3 )$$

wherein p(Pᵢ, Pⱼ) denotes a difference in pixel values between two arbitrary points Pᵢ and Pⱼ, and p₀ denotes a difference in pixel values from the arbitrary point Pᵢ, so that the parameters are defined not only with the radius but also with the pixel value.

As described above, the functions of which high frequency components being made prominent can be produced by taking the pixels values as the parameter into consideration. As a result, for example, the image interpolation can be performed within a short time simultaneously with the extraction of the characteristics of the contours. Accordingly, highly detailed images without being out-of-focus can be attained within a short time even after they have been subjected to the image processing. This means that this image processing method can be applied for the fields of images such as images for medical uses.

Now, the image processing method according to the fourth example of the present invention will be explained. The image processing method according to the fourth example of this invention is directed to the restoration of damaged parts in an object image. The restoration of damaged parts means to restore damaged parts, for example, when a partial region in an image data has been damaged or a partial region of an image has been lost. Specifically, the restoring of damages means to repair damages contained in an object image, such as scratched damages in an old picture and a portion where a solid image is concaved, to vanish the scratched damages and restore the concaved portion. At first, the range of the damaged part is specified in an object image prior to producing the functional data with use of the CSRBF method according to the present invention. For example, the range of the damaged part is specified by an enclosure or the like with use of a so-called selection tool such as image processing software. Then, the part other than the damaged range having been specified is specified. For example, the part other than the damaged part is selected with an inversion command for the selected range such as an image processing software or the like. Then, the functional data is produced for the part other than the damaged part with the CSRBF method according to the present invention. The produced functional data for the part other than the damaged part is used to interpolate the damaged part smoothly and in a continuous manner. That is, the damaged part can be restored initially from the surroundings of the specified damaged region. Since the part other than the damaged part has been expressed with the functions, it is possible to restore the damage within a short time and with a high accuracy. Furthermore, even though the damaged part extends widely or is in such a state that a solid image is concaved, it is possible to restore the damaged part at a high speed with a high accuracy. Note that, even if the functional data has not been produced for the whole part other than the damaged part, it is possible to restore the damaged part as far as the functional data has been produced for a given region surrounding the damaged part.

In the fourth example described above, the damaged part as a whole is restored at once. The image processing method according to this example is useful for restoring damages on an image in which changes in colors are occurring relatively smoothly, such as an image of the nature and a portrait. This is because that the CSRBF method obtains smooth functional data from the discrete points on an image to reconstitute the surface thereof. Whereas, when the CSRBF method that executes the surface reconstitution with smooth functions is straightly used for restoring damages on an image in which changes in colors occurs sharply like occurring on an image formed in a netted pattern, the edges of the image get in out-of-focus state, causing unfavorable result in terms of accuracy on occasions. In the following, an image processing method that can restore damages on a part which is formed in a netted pattern and the like will now be explained.

In the image processing method according to the fifth example of the present invention, an image processing is carried out locally according to the CSRBF method so that damages on a part formed in a netted pattern can be restored with a high accuracy. At first, before producing the functional data with use of the CSRBF method, a range of a damaged part in an object image is specified in the same way as that in the fourth example. Then, a given point, for example the distal end point in the specified range of the damaged part is determined as the initial point. Then, a given surrounding adjacent region to this point, which is regarded as the center, is specified and the functional data is produced for the surrounding region. Following thereto, the initial point is interpolated with the functional data for the surrounding region to restore damages. Then, the next point to the damaged part, for example a neighbor point of the initial point, is determined, and a given surrounding adjacent region to this point is specified similarly to the manner executed for the initial point. Then the functional data is produced for the surrounding adjacent region, and the point is interpolated with the functional data to restore damages. At this occasion, when restoration is carried out at the next point, the data after the restoration of the previous point has been completed is essentially used. The above-described processes are repeated, so that all damages in the specified range of the damaged part are restored. In this manner, it is possible to restore damages with a high accuracy even for damages on an image in which changes in colors occurs sharply like the changes on an image formed in a netted pattern. Besides, the restoration of damages is effected at once in the fourth example, calculations of the interpolated matrices for a number of discrete points are required at a time. Accordingly, the calculation works will be increased, and much time will be required for effecting the restoration on occasions. However, since it is possible to make the calculation works at a time less in the fifth example, the time for restoring damages in total may be reduced.

Now, the image processing method according to the sixth example will be explained below. The image processing method according to the sixth example is directed to a creation of an animation by modifying the parts of an object images. The creation of an animation means to produce animated images. More specifically, it means to animate, for example, changes in a visage of a human and to animate changes in the appearances of a solid object. At first, before producing the functional data with the CSRBF method according to the present invention, a moving part in an object image, for example a part around a mouth in case of a human face, is specified. Specifically, discrete points in the moving part are specified. Then, utilizing the CSRBF method, the functional data is produced for the specified moving part. Then, the moving points are converted in the linear form with the functional data to create an animation of changes in a visage. In this conversion, the manner to provide a displacement vector (dx, dy, dz) may be decided freely. Accordingly, it is possible to freely alter the range-specified part with the displacement vector. For example, when a part of mouth is specified, changing points around a mouth can be converted with the displacement vector to the linear form to thereby freely change the expression of the face to laughing, angry or crying face or the like. Note that, similarly, it is naturally possible to give changes to parts around eyes and the like at the same time. Furthermore, various animations, such as an animation in which a box is crushed to be deformed, can be created easily at a high speed. As described above, with the image processing method with use of a high-speed algorithm employing the CSRBF method according to the present invention, simplification of changes in a shape can be effected by localizing a region to be modified and calculations can be executed at a high speed with a memory having a small capacity.

Besides, the image processing method according to the present invention is not limited to the above-described examples, and various modifications may be made within a range without departing from the gist of the present invention. Since the image processing is not limited to the above-described examples, any image processings including modifications and changes to make an object image into a desired image, such as trimming and conflation of images, are included in the image processing specified in the present invention.

As explained above, with the image processing method according to the present invention, such an excellent advantageous effect that an image processing, such as the resolution interpolation and compression of an image, restoration of damages on an image, creation of an animation and the like, can be realized at a high speed. Furthermore, according to this invention, since an image with an arbitrary resolution can be produced with a high accuracy from an image, production of an image to which a receiver's output device can exert its full performance can be effected. Still further, since calculation works required for an image processing can be reduced with the method according to this invention, high-speed image processing can be effected even with a computer with a low-performance.

What is claimed is:

1. An image processing method for processing an object image comprising;
a step in which the CSRBF (Compactly Supported Radial Basis Functions) method is utilized to produce functional data that expresses the object image with the functions, and
a step in which the functional data produced in the step of producing the functional data is used to execute an image processing so that the object image can be a desired image,
wherein a basis function to be used in the CSRBF method is defined with the following equation;
$$ϕ ( {P}_{i} , {P}_{j} ) = \{ \begin{matrix}{( 1 - \frac{r ( {P}_{i} , {P}_{j} )}{{r}_{0}} )}^{2} , & r ( {P}_{i} , {P}_{j} ) < {r}_{0} \\ 0 , & others\end{matrix}$$
wherein r(Pᵢ, Pⱼ) denotes a distance between two arbitrary points Pᵢ and Pⱼ among a plurality of discrete points, and r₀ denotes a radius from a centered arbitrary point Pᵢ to be given as the initial value, and the functional data at a given basis function is provided with a functions represented by the following equation;
$$f ( x , y , z ) = {\sum }_{i = 1}^{N} ( {λ}_{i} ϕ ( x , y , z , {P}_{i} ) ) + {λ}_{N + 1} + {λ}_{N + 2} x + {λ}_{N + 3} y + {λ}_{N + 4} z$$
wherein λᵢ (i=1, 2, . . . , N) denotes a coefficient of basis function at the point Pi, and λ_{N+1}, λ_{N+2}, λ_{N+3} and λ_{N+4} denote a primary term coefficient, respectively,
wherein calculations of the coefficients, λ_{N+1}, λ_{N+2}, λ_{N+3} and λ_{N+4} are executed with use of a high-speed algorithm that diagonalizes interpolation matrices,
wherein the high-speed algorithm comprising;
a first step in which one point is added from the initial data to which the plurality of discrete points are included to a list, and the point added to the list is deleted from the initial data,
a second step in which a point in the vicinity of the added point in the first step is retrieved in the initial data and then added to the list, and the point added to the list is deleted from the initial data,
a third step in which a point in the vicinity of the added point in the second step is retrieved in the initial data and then added to the list, and the point added to the list is deleted from the initial data,
a fourth step in which a point out of the discrete points remaining in the initial data is added to the list when no more point to be added to the list exists, and the point added to the list is deleted from the initial data, and
a fifth step in which the first to fourth steps are repeated until no more discrete point remains in the initial data to produce diagonal matrices having band characteristic.

2. An image processing method according to claim 1, wherein the step in which the image processing is performed further comprises a step for performing an image interpolation with use of the functional data to increase or decrease the number of samplings for a coordinate so that the object image can be an image with a desired resolution.

3. An image processing method according to claim 1 or 2 further comprising a step for performing a preprocessing to the object image prior to the step for producing the functional data.

4. An image processing method according to claim 3, wherein the step for performing the preprocessing is a step for performing the wavelet transform in order to extract the characteristics of the object image.

5. An image processing method according to claim 3, wherein the step for performing the preprocessing is a step for performing simple thinning of the plurality of discrete points in order to compress the capacity of the object image.

6. An image processing method according to claim 1 or 2, wherein the basis function is further defined with an equation;
$$ϕ ( {P}_{i} , {P}_{j} ) = \{ \begin{matrix}{( 1 - \frac{r ( {P}_{i} , {P}_{j} )}{{r}_{0}} )}^{2} , & r ( {P}_{i} , {P}_{j} ) < {r}_{0} , p ( {P}_{i} , {P}_{j} ) > {p}_{0} \\ 0 , & others\end{matrix}$$
wherein P(Pᵢ, Pⱼ) denotes a difference between the pixel values of two arbitrary points Pᵢ and Pⱼ, and p₀ denotes a difference of a pixel value from the arbitrary point Pᵢ, so that a radius and a pixel value can be a parameter of the basis function, respectively.

7. An image processing method according to any of the preceding claims, wherein the step for performing the image processing is a step for restoring damages contained in the object image, and the method further comprises prior to the step for producing the functional data;
a step for specifying a range of the damaged part contained in the object image, and
a step for specifying the remaining region that is a portion given by removing the damaged part from the object image,
wherein the step for producing the functional data is then executed for the remaining region given by removing the damaged part from the object image, and
the step for restoring the damages is a step in which the range-specified damaged part is interpolated with use of the functional data for the specified remaining region produced in the step for producing the functional data to restore the damages.

8. An image processing method according to any of claims 1 to 6, wherein the step for performing the image processing is a step in which damages contained in the object image are restored, and the method further comprises prior to the step for producing the functional data;
a step for specifying a range of the damaged part contained in the object image,
a step for determining a given point in the range of the range-specified damaged part, and
a step for specifying a given surrounding adjacent region to the given point having been centered,
wherein the step for producing the functional data is then executed for the specified given surrounding region,
the step for restoring the damages is a step in which the given point is interpolated with use of the functional data for the specified given surrounding region produced in the step for producing the functional data to restore the given point, and
after the restoration of the given point has been completed, the procedure backs to the step for determining the given point in order to determine the next given point, and the step until the step for restoring the point are repeated to restore all damages in the range-specified damaged part.

9. An image processing method according to claim 1 or 2, wherein the step for performing the image processing is a step for modifying the object image to create an animation, and the method further comprises prior to the step for producing the functional data;
a step for specifying a moving part in the object image,
wherein the step for producing the functional data is then executed for the specified moving part, and
the step for creating an animation is a step in which the moving part is converted into the linear form with use of the functional data for the specified moving part produced in the step for producing the functional data to create an animation.
